(19) United States
(12) Patent Application Publication
(10) Pub. No.: US 2006/0038537 A1
(43) Pub. Date: Feb. 23, 2006

(54) Battery-operated electric hand tool machine

(76) Inventor: Bernd Heigl, Augsburg (DE)

Correspondence Address: DAVID TOREN, ESQ.;ABELMAN FRAYNE & SCHWAB, 666 THIRD AVENUE, NEW YORK, NY, 10017-5621, US

(21) Appl. No.: 10/678,561

(22) Filed: Oct. 3, 2003

(30) Foreign Application Priority Data
Oct. 7, 2002 (DE) 102 46 761.7

(51) Int. Cl. H02J 7/00

(52) U.S. Cl. 320/114

(57) ABSTRACT

A battery pack (4) for a battery operated electric hand tool machine (1) having an electric motor (2) in a machine housing (3), an exchangeable battery pack (4) and a control module (5) with a power electronics (7) for controlling the electric motor (2) and for protecting the battery pack (4). At least the power electronics (7) of the control module (5) are arranged entirely in the exchangeable battery pack (4) and are connected to the electric motor (2) via interface contacts (8).

### BACKGROUND OF THE INVENTION

The invention relates to a battery-operated electric hand tool machine such as a combination hammer, hand-held circular saw having an exchangeable storage battery pack. In particular, in efficient electrical hand tool machines, high power outputs from mains-independent power sources are provided, which are configured as compact battery modules in storage battery packs with a plurality of rechargeable power storage cells such as, for example, Li-ion cells. Power pack monitoring means such as data storage with temperature and current sensors and battery protection means with a power electronics such as load current limiters and charge regulators are required and are at times arranged in the battery pack to maintain the full capacity of these high-performance storage batteries over a long service life and many charge- discharge cycles.

Efficient drives of electric hand tool machines also have brushless electric motors, which are supplied by an inverter as part of the power electronics. The power electronics include electronic switches and/or controllers for currents in excess of 1.0 A, which are configured as IGBTs or Power MOSFETs, for example.

According to U.S. Pat. No. 6,218,806, a battery operated electric hand tool machine has an exchangeable storage battery pack with a battery pack memory and temperature sensor, which is connected in a data link with a machine data memory in the electrical hand tool machine and an associated charging unit. Power electronics are required both in the electrical hand tool machine and the associated charger unit.

According to NL9201744 a battery-operated electric hand tool machine has an integrated control module for a motor controller and charge regulation of an exchangeable storage battery pack, wherein the control module is arranged entirely in the electric hand tool machine. The storage battery pack requires as a storage battery protection means at the time of separate charging an additional power electronics in the charger unit.

In addition, JP10034564 describes a battery-operated electric hand tool machine having an exchangeable storage battery pack with battery pack monitoring means and illumination means, whose power electronics are arranged entirely in the battery pack.

In addition, US200010015579A describes a battery-operated electric hand tool machine having, in lieu of an exchangeable battery pack, an insertable power pack supplied by external power having a current-inverting power electronics.

### SUMMARY OF THE INVENTION

The object of the invention is to reduce the parts required in an output electronics. Essentially, a battery-operated electric hand tool machine having an electric motor in a machine housing and having an exchangeable battery pack as a control module with power electronics for controlling the electric motor and protecting the battery pack, wherein at least the power electronics of the control module is arranged entirely in the exchangeable battery pack and is connected to the electric motor via interface contacts.

By virtue of the arrangement of at least the power electronics of the control module in the exchangeable battery pack, these are available both to the battery pack for protection and to an electric hand tool machine connected to the battery pack for motor control.

Advantageously, the control module comprises motor control means arranged on the external machine housing and motor control means connected to the motor control switch via interface contacts for controlling the electric motor, whereby the arrangement of the motor control means is optionally in the machine housing.

Advantageously, the power electronics of the control module comprises at least the power electronics of an inverter for a brushless electric motor, whereby the arrangement of the extensive power electronics of the inverter is optionally in the machine housing.

Advantageously, the control module has rotor control means with position sensors on the brushless electric motor connected via interface contacts, for the control of the inverter depending on the rotor position of the brushless electric motor, whereby the arrangement of the rotor control means is optionally in the machine housing.

Advantageously, the control module has phase current sensors connected via interface contacts to the phase windings on the brushless electric motor for the control of the brushless electric motor, whereby the arrangement of the extensive phase current sensors are optionally in the machine housing.

Advantageously, the control module includes the battery pack monitoring means of the battery pack integrated in a common component.

Advantageously, the control module includes the charging regulator of the battery pack that is available to an associated charging unit for charge regulation, which does not require its own power electronics for charge regulation.

Advantageously, the rechargeable current storage cells are configured modularly within the exchangeable battery pack and electrically connected to the control module via detachable connectors, whereby the current storage cells within the battery pack having the control module can be renewed at the end of their service life.

The associated battery pack has at least three interface contacts electrically connected to the power electronics, whereby a external current path via two interface contacts through the power electronics is controllable using a third external contact.

Advantageously, the battery pack has eight interface contacts, whereby three are connected via the phase current sensors to the power electronics and another five are connected to the integrated control module.

### BRIEF DESCRIPTION OF THE INVENTION

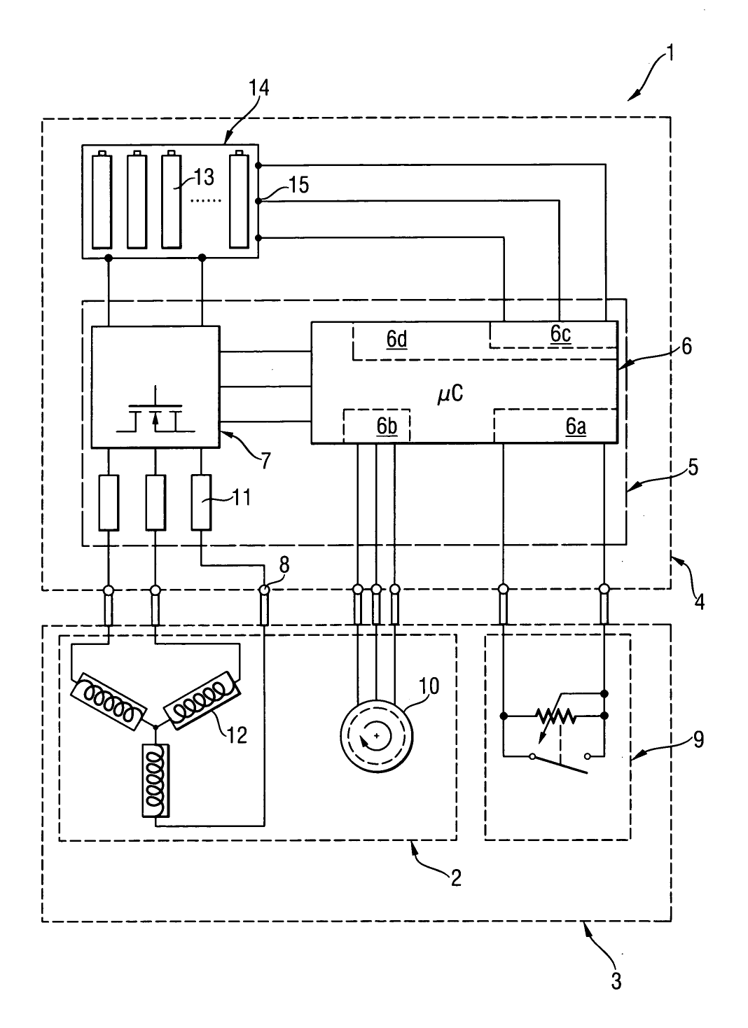

The exemplary embodiment of the invention will be more completely described with reference to the drawings, wherein FIG. 1 shows a wiring diagram as a battery-operated electric hand tool machine.

### DETAILED DESCRIPTION OF THE INVENTION

FIG. 1 shows a battery-operated electric hand tool machine 1 having a brushless electric motor 2 located in a machine housing 3, and having a control Module 5 with an exchangeable battery pack 4. The control module 5 is formed as an integrated microcontroller 6 associated with power electronics 7 for controlling the electric motor 2 and for protecting the battery pack 4. The power electronics 7 of the control module 5 is arranged entirely in the exchangeable battery pack 4 and connected to the electric motor 2 via interface contacts 8. The microcontroller 6 includes motor control means 6a arranged with control means 9 arranged on the external machine housing 3, such as a motor control switch, via two interface contacts 8 for controlling the electric motor 2 and rotor control means having position sensors 10 on the brushless electric motor 2 via three interface contacts 8 for controlling an inverter formed by the power electronics 7 depending on the rotor position of the brushless electric motor 2. The inverter formed by the power electronics 7 is connected to the three stellar wired phase coils 12 of the brushless electric motor 2 via a phase current sensor 11 of the control module 15 and one each interface contact 8. The microcontroller 6 includes the storage battery monitoring means 6c and the charge regulator 6d of the battery pack 4 for the power electronics 7. The rechargeable current storage cells are configured modularly as a cell set 14 inside the exchangeable battery pack 4 and electrically connected to the control module 15 via removable connectors 15.

What is claimed is:

1. A battery-operated electric hand tool machine,comprising an electric motor (2) in a machine housing (3), an exchangeable battery pack (4),and a control module (5) with a power electronics (7) for motor control of the electric motor (2) and protection of the battery pack (4), wherein at least the power electronics (7) of the control module (5) is arranged entirely in the replaceable battery pack (4) and connected to the electric motor (2) via interface contacts (8).

2. The electric hand tool machine of claim 1, wherein the control module (5) comprises motor control means (6a) for controlling the electrical motor (2), and wherein the motor control means (6a) is connected via interface contacts (8) to control means (9) arranged on the outside of the machine housing (3).

3. The electric hand tool machine of claim 2, wherein the power electronics (7) of the control module (5) comprises at least the power electronics (7) of an inverter for a brushless electric motor (2).

4. The electric hand tool machine of claim 3, wherein the control module (5) comprises rotor control means (6b) connected to position sensors (10) on the brushless electric motor (2) via interface contacts (8) for controlling the inverter depending on the rotor position of the brushless electric motor (2).

5. The electric hand tool machine of claim 4, wherein the control module (5) comprises phase current sensors (11) for controlling the brushless electric motor (2) and wherein the brushless electric motor (2) is connected via interface contacts (8) to the phase coils (12) on the brushless electric motor (2).

6. The electric hand tool machine of claim 5, wherein the control module (5) includes the storage battery monitoring means (6c) of the battery back (4).

7. The electric hand tool machine of claim 6, wherein the control means (5) contains the charge controller (6d) of the battery pack (4).

8. The electric hand tool machine of claim 7, wherein the rechargeable current storage cells (13) are modularly configured inside of the exchangeable battery pack (4) and are electrically connected via removable connectors (15) to the control module (5).

9. A storage battery with interface contacts (8) for exchangeable connection to a machine housing (3) of an electric hand tool machine (1) having an electric motor (2), wherein a power electronics (7) is electrically connected with at least three interface contacts (8).

10. The battery pack of claim 1, wherein at least eight interface contacts (8) are present.
